(19) United States
(12) Patent Application Publication
(10) Pub. No.: US 2024/0359485 A1
(43) Pub. Date: Oct. 31, 2024

(54) INSPECTION METHOD AND STORAGE MEDIUM

(71) Applicant: CANON KABUSHIKI KAISHA, Tokyo (JP)

(72) Inventor: MASAO FURUKAWA, Kanagawa (JP)

(21) Appl. No.: 18/632,505

(22) Filed: Apr. 11, 2024

(30) Foreign Application Priority Data
Apr. 26, 2023 (JP) 2023-072349

(51) Int. Cl. B41J 2/21

(52) U.S. Cl. CPC B41J 2/2146; B41J 2/2135

(57) ABSTRACT

An object of the present disclosure is to reduce the rise in inspection cost in a case of inspecting the droplet landing accuracy of each individual element substrate and also the droplet landing accuracy at a joint portion between the adjacent substrates. One embodiment of the present invention provides a method for inspecting a liquid ejection head in which element substrates are arrayed, each element substrate having an ejection port array including ejection ports for ejecting a liquid, the method including: printing an inspection pattern on a print medium; and reading the pattern printed on the print medium. The pattern includes a first pattern printed using ejection ports covering a joint portion between adjacent element substrates, and a second pattern printed using ejection ports not used in the printing of the first pattern and at least one of the ejection ports used in the printing of the first pattern.

### BACKGROUND

### Field

The present disclosure relates to a technique for inspecting the droplet landing accuracy of a liquid ejection head.

### Description of the Related Art

Inkjet-type printing apparatuses have liquid ejection heads that eject liquids such as inks. For inspection of the droplet landing accuracy of a long liquid ejection head including multiple element substrates, an inspection method can be employed in which an inspection pattern in the form of a single patch is printed for each element substrate, and the positions of the landed dots are detected to evaluate the droplet landing accuracy. Japanese Patent Laid-Open No. 2010-023459 discloses a method for inspecting printing quality of a long head formed by connecting multiple short heads.

Accurate inspection of the printing quality of a long liquid ejection head requires not only the above-mentioned inspection of the droplet landing accuracy of each individual element substrate but also inspection of the droplet landing accuracy at the portion between the adjacent element substrates (hereinafter referred to also as “joint portion”). One may consider a method for such an inspection that involves printing two types of inspection patterns being an inspection pattern for each individual element substrate and an inspection pattern for the joint portion, and inspecting the droplet landing accuracy based on each of the printed patterns.

An example of these two types of inspection patterns will now be described with reference to FIGS. 17A and 17B. FIGS. 17A and 17B are schematic diagrams illustrating positional relationships between element substrates B and inspection patterns. FIG. 17A illustrates a pattern printed by using only the ejection ports included in each single element substrate, such as element substrates B1 and B2. This pattern is for inspecting the droplet landing accuracy of each individual element substrate. As illustrated in FIG. 17A, the pattern is printed in two separate lines such that patterns printed by adjacent element substrates in the form of individual patches are in different lines.

FIG. 17B, on the other hand, illustrates patterns formed in the form of individual patches by using ejection ports formed in the pairs of element substrates sitting adjacent to each other with a joint portion therebetween, such as the element substrates B1 and B2 and the element substrates B2 and B3. These patterns are for inspecting the droplet landing accuracy at the joint portions. As illustrated in FIG. 17B, the pattern printed in the form of a single patch across a joint portion situated next to another joint portion is printed in the line different from that for the pattern printed in the form of a single patch across this other joint portion.

### SUMMARY

Here, in the inspection method in which two types of inspection patterns for inspecting droplet landing accuracy are printed (two lines of patterns for each type, i.e., four lines of patterns in total) as exemplarily illustrated in FIGS. 17A and 17B, the amount of print media to be consumed in the inspection is large. This raises the inspection cost.

In view of the above, an object of the present disclosure is to reduce the rise in inspection cost in a case of inspecting the droplet landing accuracy of each individual element substrate and also the droplet landing accuracy at the joint portion between the adjacent element substrates.

One embodiment of the present disclosure provides an inspection method for inspecting a liquid ejection head in which a plurality of element substrates are arrayed, the plurality of element substrates each being a substrate in which are formed an ejection port array consisting of a plurality of ejection ports for ejecting a liquid, the inspection method including: printing an inspection pattern on a print medium; reading the inspection pattern printed on the print medium in the printing; calculating droplet landing accuracy of each individual one of the plurality of element substrates based on positional coordinates of landed dots included in the inspection pattern read in the reading; and calculating droplet landing accuracy at a joint portion between adjacent ones of the element substrates based on the positional coordinates, wherein the inspection pattern includes a first pattern printed by using a plurality of ejection ports covering the joint portion between the adjacent element substrates, and a second pattern printed by using ejection ports not used in the printing of the first pattern and at least one of the ejection ports used in the printing of the first pattern.

Further features of the present invention will become apparent from the following description of exemplary embodiments with reference to the attached drawings.

### BRIEF DESCRIPTION OF THE DRAWINGS

FIGS. 1A to 1C are views illustrating a liquid ejection head and element substrates;

FIG. 2 is a perspective view of an inspection apparatus;

FIG. 3 is a block diagram of the inspection apparatus;

FIG. 4 is a flowchart of an inspection method for inspecting droplet landing accuracy;

FIG. 5 is a diagram illustrating a positional relationship between an inspection pattern and the element substrates;

FIG. 6 is a diagram illustrating a relationship between ejection ports and landed dots;

FIG. 7 is a diagram explaining a method of reading the inspection pattern;

FIGS. 8A and 8B are diagrams explaining the read inspection pattern;

FIG. 9 is a diagram explaining a coordinate conversion process for converting landed dots in different coordinate systems into landed dots in the same coordinate system;

FIG. 10 is a diagram explaining a virtual lattice;

FIGS. 11A to 11D are diagrams explaining a method of deriving the virtual lattice;

FIG. 12 is a diagram explaining a method of calculating the amount of misalignment;

FIGS. 13A and 13B are diagrams explaining calculation of the droplet landing accuracy at a joint portion;

FIG. 14 is a diagram illustrating a positional relationship between an inspection pattern and the element substrates;

FIG. 15 is a diagram explaining a method of reading the inspection pattern;

FIGS. 16A-to 16D are diagrams explaining calculation of droplet landing accuracy; and

FIGS. 17A and 17B are diagrams illustrating conventional inspection patterns.

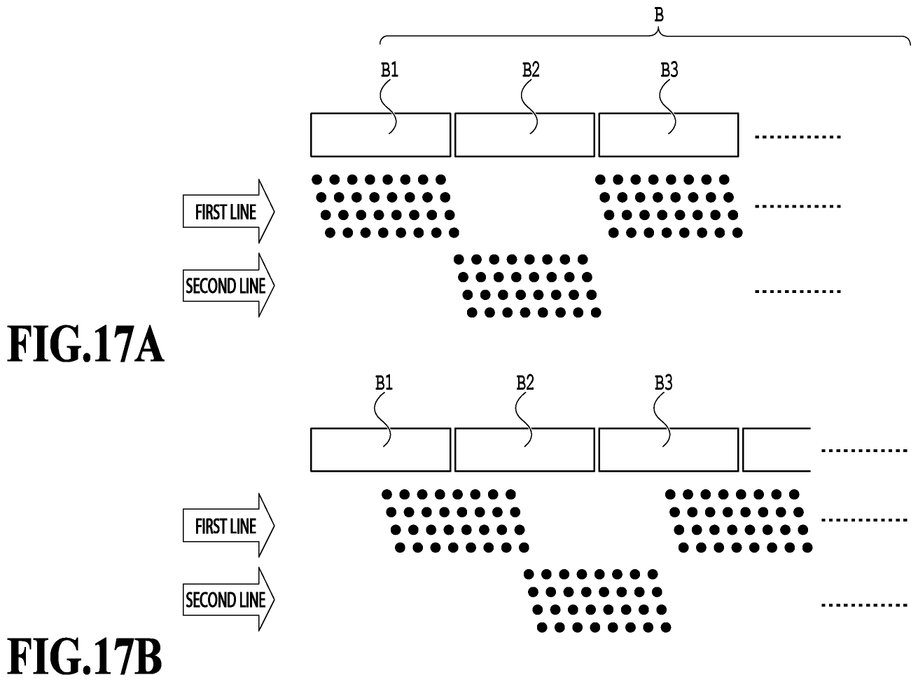

### DESCRIPTION OF THE EMBODIMENTS

Embodiments according to the present disclosure will be described below with reference to drawings. It is to be noted that elements in drawings having the same function or intended for the same purpose are denoted by the same reference sign and redundant description thereof may be omitted.

### <Liquid Ejection Head>

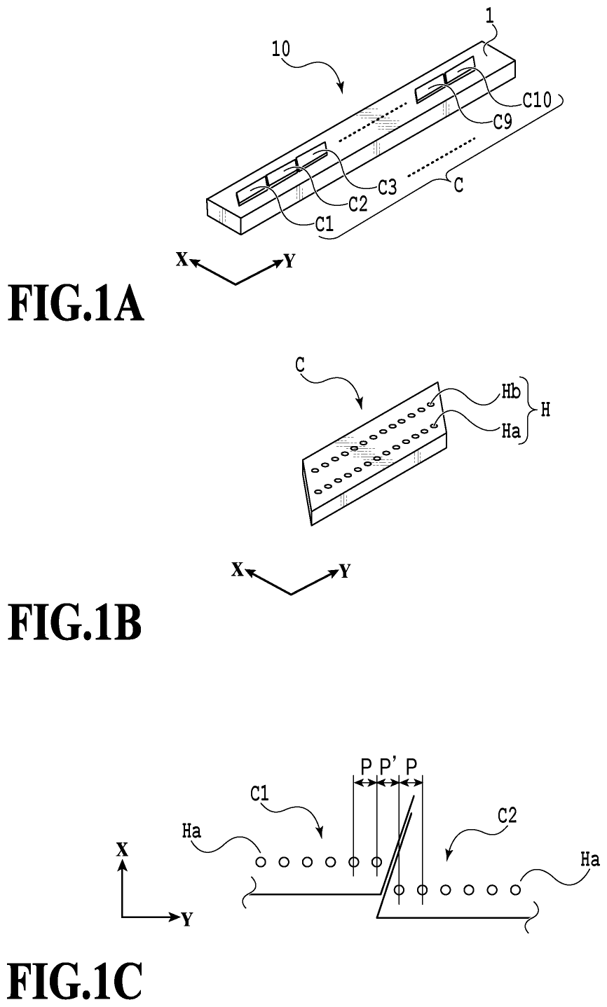

FIGS. 1A to 1C are views illustrating an example of a liquid ejection head 10 which can be inspected with the technique of the present disclosure. FIG. 1A is a perspective view of the liquid ejection head 10. As illustrated in FIG. 1A, the liquid ejection head 10 has a support member 1 and multiple element substrates C that eject a liquid such as an ink. The support member 1 supports the multiple element substrates C. The multiple element substrates C are joined to the support member 1 with a layer of an adhesive agent (not illustrated) therebetween. The liquid ejection head 10 includes 10 element substrates C1 to C10 disposed straight on the same surface of the support member 1 as the element substrates C. The element substrates C1 to C10 may each have the same or substantially the same shape or have a different shape. In FIG. 1A, the element substrates C1 to C10 have the same shape, and it is a parallelogram as viewed from above, but may be a quadrilateral shape such as a rectangle or a trapezoid. Also, the number of element substrates C is not limited to 10, and only needs to be at least 2. In FIGS. 1A to 1C, the array direction of the element substrates C1 to C10 is defined as the Y direction, and the direction orthogonal to the Y direction on the same surface of the support member 1 is defined as the X direction. In addition, in this description, the term “element substrates C” will be used to collectively referred to the element substrates C1 to C10, and the element substrates C1 to C10 will be denoted simply as “element substrate(s) C” in a case where they do not particularly need to be distinguished from one another. Similar rules apply also to other constituent elements (e.g., landed dots D and the like to be described later).

FIG. 1B is an enlarged perspective view of one element substrate C. As illustrated in FIG. 1B, each element substrate C includes multiple ejection ports H from which to eject the liquid. The ejection ports H are arranged in two lines as ejection port arrays Ha and Hb substantially parallel to each other in the longitudinal direction of the element substrate C (Y direction). Each of the ejection port arrays Ha and Hb includes 512 ejection ports H arrayed at intervals of 42.3 micrometers. In FIG. 1B, illustration of many ejection ports is omitted. The length of the ejection port arrays Ha and Hb in each element substrate C is approximately 21.6 millimeters. The number of ejection port arrays is not limited to two and may be any number.

Though not illustrated, each element substrate C includes pressure chambers which communicates with the ejection ports H, supply ports through which to supply the liquid to the pressure chambers, and pressure generation elements which generate a pressure for ejecting the liquid. The ejection ports H and the pressure generation elements are disposed so as to face each other across the pressure chambers, and the liquid inside the pressure chambers is ejected from the ejection ports H by the pressure generated by the pressure generation elements.

FIG. 1C is an enlarged view of portions of element substrates in the liquid ejection head 10 where the element substrates are adjacent to each other. While the adjacent portions of the element substrates C1 and C2 are depicted in FIG. 1C, the adjacent portions of other elements, i.e., the adjacent portions of the element substrates C2 and C3, the element substrates C3 and C4, and so on, are similar as well. Also, the illustrated ejection port array in each of the element substrates C1 and C2 is the ejection port array Ha. While the arrangement distance (pitch P) between the ejection ports H in each element substrate C is 42.3 micrometers, as mentioned above, the distance (pitch P′) between the ejection ports H at the portion where the element substrates are connected is also the same distance. Accordingly, the total length in the Y direction of the nozzle arrays of the 10 element substrates C connected to one another is approximately 216 millimeters.

### <Inspection Apparatus>

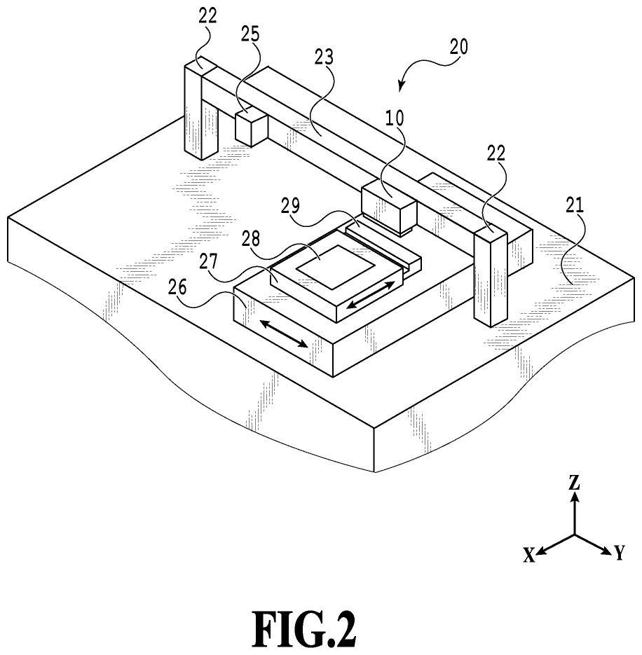

FIG. 2 is a perspective view illustrating an inspection apparatus 20 for inspecting printing quality of the liquid ejection head 10, specifically, the droplet landing accuracy of the liquid. The inspection apparatus 20 has a horizontal beam 23 placed between two support columns 22 on a surface plate 21. The liquid ejection head 10 to be inspected and a camera 25 for reading an inspection pattern are attached to this beam 23 with their front sides facing down. A lens not illustrated is attached to the camera 25. A Y stage 26 capable of moving in the Y direction between the support columns 22 is mounted on the surface plate 21. An X stage 27 capable of moving in the X direction (the direction in which a print medium 28 moves relative to the liquid ejection head 10) is mounted on the Y stage 26. The print medium 28 is fixed to the X stage 27 by suction. Moreover, a liquid receiver 29 is fixed to the X stage 27. The liquid receiver 29 is for receiving the liquid that is ejected from the liquid ejection head 10 but not caused to land on the print medium 28. Note that “the liquid . . . not caused to land on the print medium 28” is the liquid ejected toward the receiver 29 from all ejection ports for achieving stable liquid ejection, for example, in a case of ejecting the liquid after a certain time of not ejecting the liquid or a longer time. In the case of ejecting the liquid after the certain time of not ejecting the liquid or a longer time, the liquid near the ejection ports has concentrated, thus causing unstable ejection (the viscosity of the liquid has risen, thus making it difficult to eject the liquid). To remedy this condition, it is necessary to eject the thickened liquid to the receiver 29. Note that this liquid ejection performed in advance for stable ejection will be referred to herein as “preliminary ejection” or the like.

To inspect the droplet landing accuracy of the liquid ejection head 10, the Y stage 26 is moved to under the liquid ejection head 10, and the inspection pattern is printed on the print medium 28 by driving the X stage 27 and ejecting the liquid from the liquid ejection head 10 in synchronization with each other. Then, the Y stage 26 and the X stage 27 are driven so as to position the inspection pattern under the camera 25. Thereafter, the inspection pattern printed on the print medium 28 is read with the camera 25, and the preciseness of positions of the landed dots forming the inspection pattern is evaluated to inspect the droplet landing accuracy. Note that the camera 25 in FIG. 2 is a line camera with an array of 8192 square light receiving elements each measuring 3.5 micrometers on one side. The magnification of the lens attached to the camera is 0.7, so that the reading width is approximately 41 millimeters.

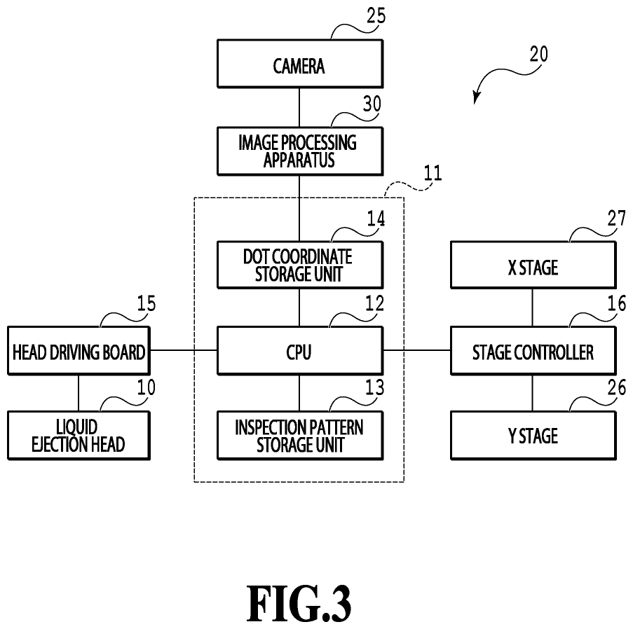

Next, connection between constituent devices of the inspection apparatus 20, data, and so on will be described. FIG. 3 is a block diagram of the inspection apparatus 20. The device mainly responsible for the processing of the inspection apparatus 20 is a computer 11. The computer 11 incorporates a central processing unit (CPU) 12 that controls data processing and devices, an inspection pattern storage unit 13 that stores inspection pattern data, and a dot coordinate storage unit 14 that stores positional coordinate data of read landed dots. A stage controller 16 controls the X stage 27 and the Y stage 26. The stage controller 16 controls the stages based on commands received from the CPU 12. The liquid ejection head 10 is controlled by creating serial data suitable for driving the head from a command output from the CPU 12 with a head driving board 15, and transferring that serial data to the head. The camera 25 reads the inspection pattern and sends data of the read inspection pattern to an image processing apparatus 30 as image information. The image processing apparatus 30 detects the positional coordinates of all landed dots. The image processing apparatus 30 sends data of the positional coordinates of all landed dots to the computer 11, which in turn stores the data in the dot coordinate storage unit 14.

### First Embodiment

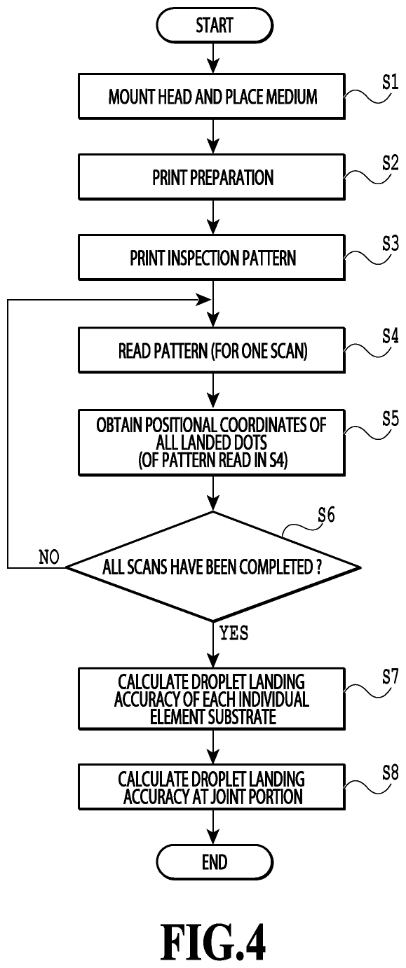

A droplet landing accuracy inspection method according to a first embodiment will now be described below with reference to FIGS. 4 to 13B. FIG. 4 is a flowchart illustrating the droplet landing accuracy inspection method according to the present embodiment.

First, in step S1, the user mounts the liquid ejection head 10 to be inspected on the inspection apparatus 20, and places the print medium 28 on the X stage 27. In the following, “step S_” will be abbreviated as “S_”.

Next, in S2, the CPU 12 moves the X stage 27 and the Y stage 26 and performs preliminary ejection of the ink as a print preparation process. Specifically, the CPU 12 moves the X stage 27 and the Y stage 26 to a predetermined initial position. The “initial position” refers to such a position that the ink receiver 29 fixed to the X stage 27 are located immediately under the liquid ejection head 10. At this position, the ink is filled into the liquid ejection head 10 and ejected from the ejection ports H toward the inside of the ink receiver 29 a given number of times. In the present embodiment, regarding the given number of times, preliminary ejection is performed 100 times from each ejection port H.

Next, in S3, the CPU 12 prints the inspection pattern on the print medium 28.

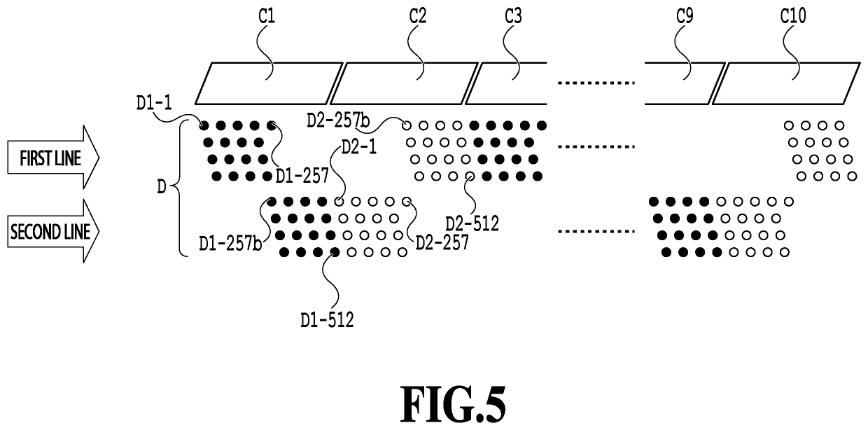

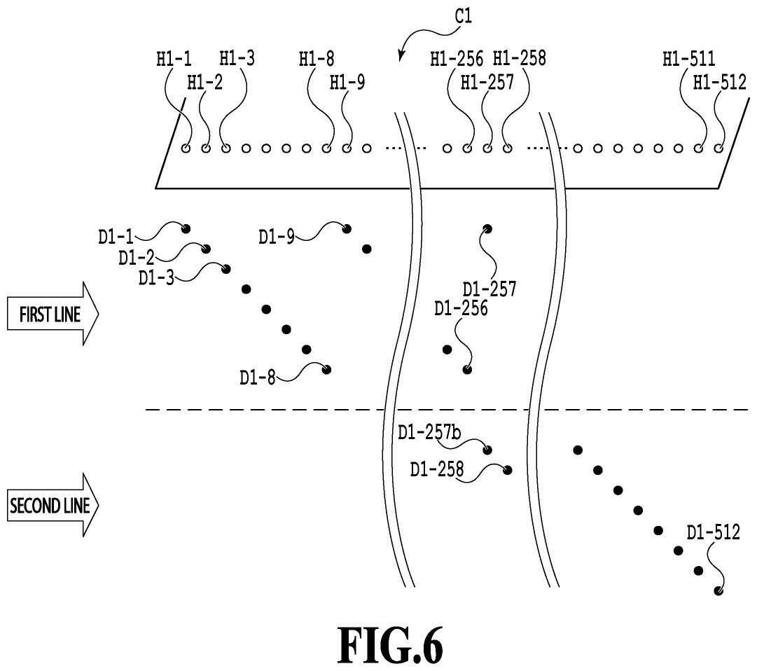

The printing is performed by driving the X stage 27, ejecting the liquid from the ejection ports H, and conveying the print medium 28 in synchronization with one another. The inspection pattern printed in this step is a pattern stored in the inspection pattern storage unit 13. The inspection pattern printed in S3 will now be described with reference to FIGS. 5 and 6.

FIG. 5 is a schematic diagram illustrating a positional relationship between landed dots D that were ejected from ejection ports H in the element substrates C and landed on the print medium 28. FIG. 6 is an enlarged diagram of the element substrate C1 and the landed dots from the element substrate C1 in FIG. 5. Note that the inspection pattern formed by all landed dots D illustrated in FIG. 5 is an inspection pattern printed by using only the ejection ports of the ejection port array Hain each element substrate C. Though not illustrated, the printing of this pattern is followed by printing of a similar inspection pattern using the ejection ports of the ejection port array Hb. The calculation of the droplet landing accuracy to be described later is the same for landed dots from both ejection port arrays. For this reason, the following description will be given only for the ejection port array Ha, and description is omitted for the other.

In FIG. 6, 512 ejection ports H are formed in the ejection port array Ha in the element substrate C1, which are denoted by reference signs H1-1 to H1-512, respectively. In the reference sign given to each ejection port, the number following the hyphen (1 to 512) represents the ejection port's number. Reference signs D1-1 to D1-512 given to landed dots that were ejected from the ejection ports H1-1 to H1-512 and landed are similar to the reference signs of the ejection ports. Each number following the hyphen (1 to 512) represents the corresponding landed dot's number.

In FIG. 6, the relationship between one ejection port and the corresponding landed dot is indicated by giving the same number to the ejection port and the landed dot. For example, the landed dot ejected from the ejection port H1-1 is D1-1, and the landed dot ejected from the ejection port H1-512 is D1-512. In a case where there are multiple landed dots from the same ejection port, an alphabetical letter is suffixed to the number of the second or subsequent landed dot. For example, the landed dots from the ejection port H1-257 include not only the landed dot D1-257 but also a landed dot D1-257b. These relationships between ejection ports and landed dots apply not only to the element substrate C1 but also to the other element substrates, such as the element substrates C2 to C10. Incidentally, as illustrated in FIG. 6, the ejection port H1-257 is a substantially center ejection port in the ejection port array.

As illustrated in FIG. 5, the inspection pattern includes two lines of patterns per ejection port array. The first line of the pattern is printed by using the ejection ports with ejection port numbers 1 to 257 in the odd-numbered element substrates C1, C3, . . . , C9 and the ejection ports with ejection port numbers 257 to 512 in the even-numbered element substrates C2, C4, . . . , C10. Meanwhile, a detailed positional relationship between the landed dots will be described later. The number of landed dots in the first line ejected by using the element substrate C1 is 257 (D1-1 to D1-257), and the number of landed dots in the first line ejected by using the element substrate C2 is 256 (D2-257b to D2-512).

The second line of the pattern is printed by using the ejection ports with ejection port numbers 257 to 512 in the odd-numbered element substrates C1, C3, . . . , C9 and the ejection ports with ejection port numbers 1 to 257 in the even-numbered element substrates C2, C4, . . . , C10. The number of landed dots in the second line ejected by using the element substrate C1 is 256 (D1-257b to D1-512), and the number of landed dots in the second line ejected by using the element substrate C2 is 257 (D2-1 to D2-257). In FIG. 5, the black dots are illustrated as the landed dots D from the odd-numbered element substrates C1, C3, . . . , C9, and the white dots are illustrated as the landed dots D from the even-numbered element substrates C2, C4, . . . , C10.

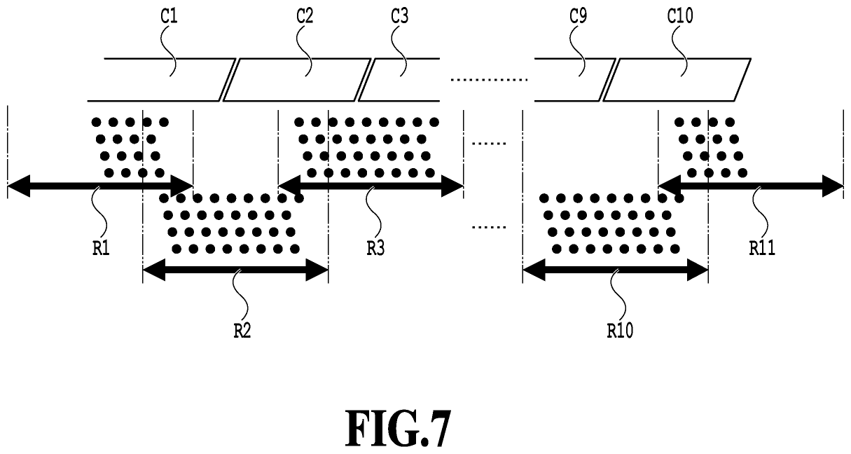

After S3 is S4, in which the CPU 12 reads a portion of the inspection pattern printed in S3 corresponding to a single scan with the camera 25. The reading of the pattern will now be described with reference to FIG. 7. The image reading width of the camera 25 mounted on the inspection apparatus 20 is approximately 41 millimeters, as mentioned earlier. On the other hand, the total length of the nozzle arrays of the element substrates C1 to C10 connected to one another is approximately 216 millimeters. Thus, it is impossible to read the entire pattern in a single scan. It is therefore necessary to read the pattern by performing multiple scans. As illustrated in FIG. 7, the entire pattern is read in 11 scans R1 to R11. The arrows depicted in FIG. 7 each indicate the reading width. In the first scan R1, the camera 25 reads a portion of the pattern printed by approximately half of the ejection ports in the element substrate C1. In the 2nd to 10th scans R2 to R10, the camera 25 reads a portion of the pattern printed in the form of a patch by two adjacent element substrates (e.g., the element substrates C1 and C2). In the 11th scan R11, the camera 25 reads a portion of the pattern printed by approximately half of the ejection ports in the element substrate C10.

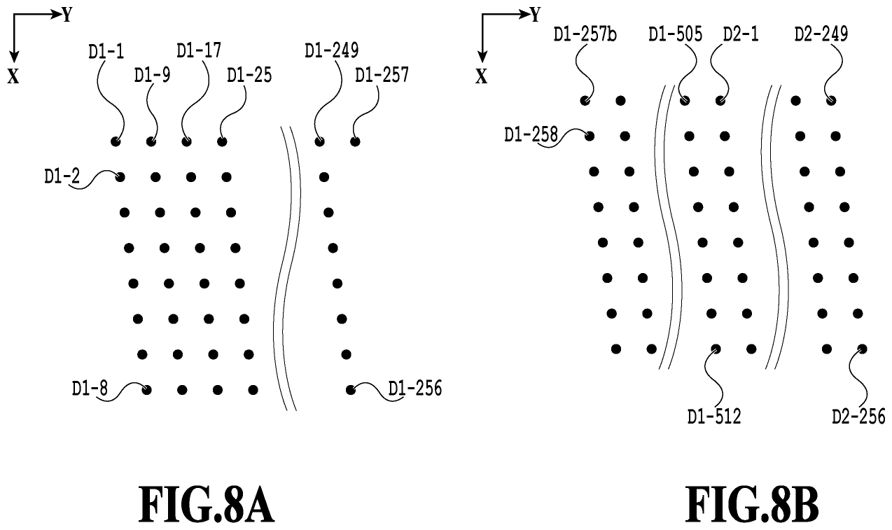

Next, in S5, the CPU 12 obtains coordinate information indicating the position of every landed dot forming the pattern read in S4. Details of the pattern read in S4 will now be described with reference to FIGS. 8A and 8B.

FIG. 8A is a portion of the pattern read in the first scan R1, indicating the landed dots D1-1 to D1-257 ejected from the 1st to 257th ejection ports H-1 to H1-257 in the element substrate C1. The landed dots D are arranged in such a shape that the ejection ports H are divided in series into groups of eight ejection ports from an end of the nozzle array, and the ejection ports H in each group eject landed dots D in the order of arrangement at intervals of a predetermined pitch (at intervals of 169.2 micrometers) in the X direction. With the group with the first to eighth ejection ports H1-1 to H1-8, the landed dot D1-1 corresponding to the first ejection port H1-1 is located at the top in FIG. 8A, and the landed dot D1-2 corresponding to the second ejection port H1-2 is located at a position spaced from the landed dot D1-1 by the predetermined pitch in the X direction. The subsequent landed dots up to D1-8 are present in series at intervals of the predetermined pitch. Note that the positions of the landed dots D mentioned above are the ideal positions. In reality, dots may land at positions slightly offset from the ideal positions due to various factors.

The position of the landed dot D1-9 corresponding to the ninth ejection ports H1-9 in the X direction is the same as the position of the landed dot D1-1 in the X direction. Likewise, the positions of the subsequent landed dots D1-17, D1-25, . . . , D1-249, and D1-257 in the X direction are the same as the position of the landed dot D1-1 in the X direction. Although the ejection ports H are divided into groups of eight ejection ports as mentioned above, only the 257th ejection port H1-257 does not belong a group of eight ejection ports and is a single independent ejection port in the case of printing the pattern in FIG. 8A.

FIG. 8B is a portion of the pattern read in the second scan R2. This illustrates the landed dots D1-257b to D1-512 corresponding to the 257 the to 512th ejection ports H1-257 to H1-512 in the element substrate C1 and the landed dots D2-1 to D2-256 corresponding to the 1st to 256th ejection ports H2-1 to H2-256 in the element substrate C2. In S5, the CPU 12 causes the image processing apparatus 30 to process the pattern read by scanning to detect the coordinates of the center position of every landed dot D and obtain data of the detected coordinates, and stores the obtained data in the dot coordinate storage unit 14. Incidentally, the coordinates are obtained as absolute coordinates in the scan.

After S5 is S6, in which the CPU 12 determines whether the last scan R11 has been completed in the reading of the pattern. If the result of the determination in this step is positive, the CPU 12 proceeds to S7. If the result of the determination in this step is negative, the CPU 12 returns to S4 and repeats S4 to S6 until completing the scan R11.

Next, in S7, the CPU 12 calculates the droplet landing accuracy of each individual element substrate. In the following, the calculation of the droplet landing accuracy of the element substrate C1 will be described as an example. The calculation of the droplet landing accuracy of the other element substrates C2 to C10 is similar to that for the element substrate C1, and description thereof is therefore omitted. The coordinates of the landed dots D from the element substrate C1 include the coordinates of the landed dots D obtained by the scan R1 and the coordinates of the landed dots D obtained by the scan R2, and the coordinate system is different between the scans R1 and R2.

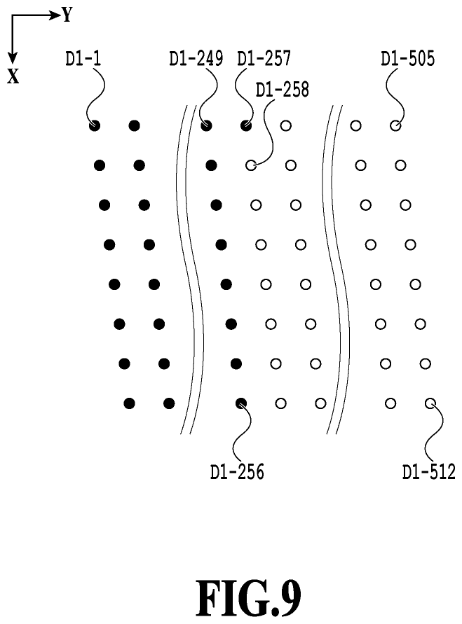

First, the CPU 12 calculates the relative coordinates of the dot positions of the landed dots D1-258 to D1-512 in FIG. 8B that are based on the landed dot D1-257b. Then, these relative coordinates of the landed dots D1-258 to D1-512 are assumed as relative coordinates from the landed dot D1-257 in FIG. 8A and calculated as coordinates in the coordinate system of the scan R1. In this way, all of the landed dots D1-1 to D1-512 from the element substrate C1 can be expressed in the same coordinate system. FIG. 9 illustrates the landed dots D1-1 to D1-512 incorporated in the same coordinate system. In FIG. 9, the black dots represent the landed dots D read in the scan R1, and the white dots represent the landed dots D read in the scan R2.

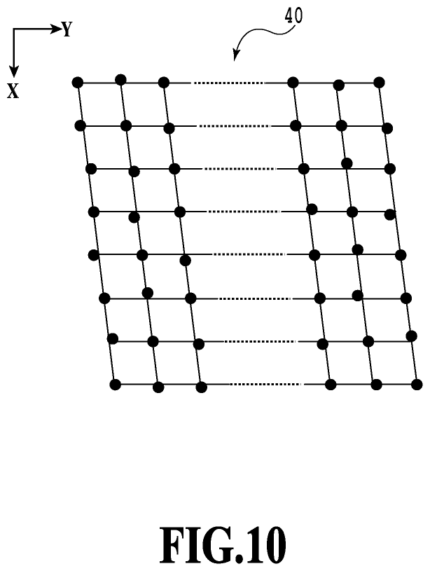

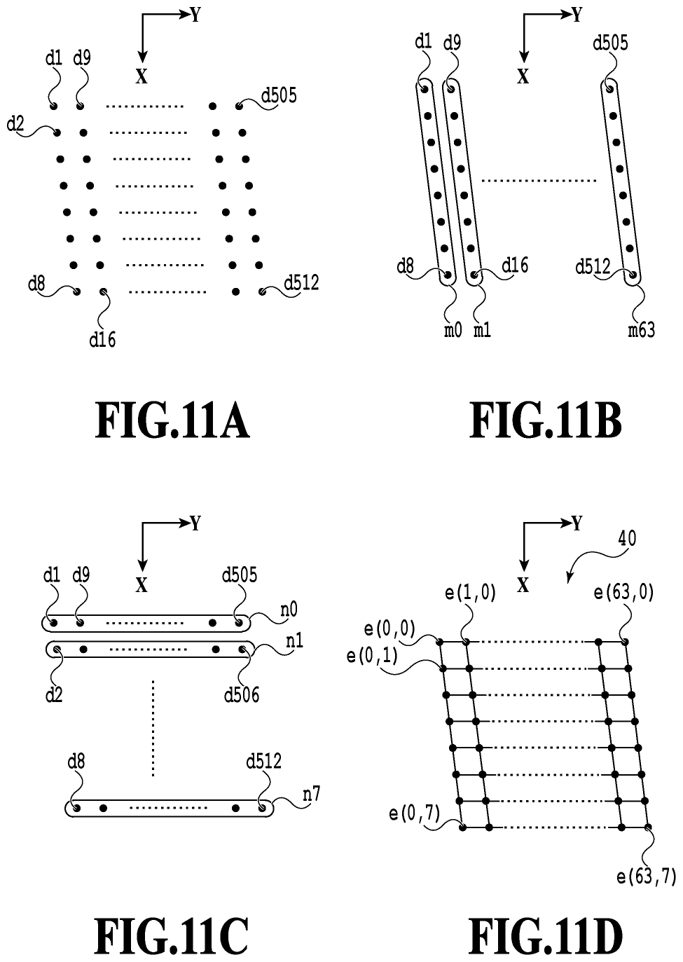

Next, the coordinates of the 512 landed dots are used to derive a lattice based on which to calculate the amount of misalignment of each dot (hereinafter referred to as “virtual lattice”). FIG. 10 is a diagram illustrating an example of the virtual lattice derived based on the landed dot coordinates. A virtual lattice 40 can be derived based on the coordinates of all landed dots D. The lattice pitch in the X direction is constant, and the lattice pitch in the Y direction is constant as well. In this example, the lattice pitches in the X and Y directions are different, but may be the same. The positions of the virtual lattice 40 are set so as to minimize the sum of the amounts of misalignment (corresponding to all intersection points in the virtual lattice 40) each calculated as the distance between the coordinates of an intersection point in the virtual lattice 40 and the coordinates of the actual landed dot corresponding to this intersection point. A method of calculating the positions in the virtual lattice 40 will now be described below with reference to FIGS. 11A to 11D.

FIGS. 11A to 11D are schematic diagrams illustrating a method of calculating the positions in the virtual lattice 40 and its lattice pitches based on the coordinates of the landed dots D. In the following, calculation of the positions in a virtual lattice used as a basis in inspection of the droplet landing accuracy of 512 landed dots d1 to d512 as illustrated in FIG. 11A will be described as an example. The eight landed dots d1 to d8 are arranged in this order as a straight array of successive dots toward the bottom right of the drawing. The pitch between the dots in the X direction in this example is 169.2 micrometers. The landed dots d9 to d16, . . . , d505 to d512 are likewise arranged as straight arrays of successive dots toward the bottom right of the drawing. In the following, the numerical values 1 to 512 given in the landed dots' reference signs d1 of d512 will also be referred to as “landed dot numbers”.

Next, as illustrated in FIG. 11B, these 512 landed dots d1 to d512 are divided into groups m0 to m63 of 8 landed dots arranged straight toward the bottom right of the drawing. Hereinafter, each of the groups m0 to m63 will be referred as “oblique group”. The group m0 at the leftmost position in FIG. 11B includes the landed dots d1 to d8. The group ml to the right of the group m0 includes the landed dots d9 to d16. The rightmost group m63 includes the landed dots d505 to d512. Hereinafter, the numerical values 0 to 63 in the oblique groups' reference signs m0 to m63 will also be referred to as “oblique group numbers”.

Next, as illustrated in FIG. 11C, the 512 landed dots d1 to d512 are divided into eight groups n0 to n7 extending straight in the Y direction. Hereinafter, each of the groups n0 to n7 will be referred to as “horizontal group”. Moreover, the numerical values 0 to 7 in the horizontal groups' reference signs n0 to n7 will also be referred to as “horizontal group numbers”.

Next, as illustrated in FIG. 11D, the representation of reference signs d1 to d512 indicating the landed dots in FIGS. 11A to 11C is changed to a representation e(m, n). In the representation, m indicates the oblique group number mentioned above, and n indicates the horizontal group number. For example, the landed dot d1, which is included in the oblique group 0 and the horizontal group 0, is represented as e(0, 0) and the landed dot d512, which is included in the oblique group 63 and the horizontal group 7, is represented as e(63, 7). The virtual lattice 40 has a reference position at the closest intersection point to e(0, 0) in the lattice, and this intersection point is represented as k(0, 0). The X coordinate in k(0, 0), or Xk(0, 0), and the Y coordinate, or Yk(0, 0), can be calculated from the following equations.

$$Xk ( 0 , 0 ) = ( {\sum }_{d = 1}^{512} Xd - 169.2 {\sum }_{d = 1}^{512} n ) / 512 \qquad Equation ( 1 )$$

$$Yk ( 0 , 0 ) = ( {\sum }_{d = I}^{512} Yd - 42.3 {\sum }_{d = 1}^{512} ( 8 m + n ) ) / 512 \qquad Equation ( 2 )$$

The parameters in Equations (1) and (2) are as follows.
d: landed dot number
m: the number of the oblique group including the landed dot with the number d
n: the number of the horizontal group including the landed dot with the number d
Xd: the X coordinate of the landed dot with the number d
Yd: the Y coordinate of the landed dot with the number d
   Incidentally, the units of the calculation results of Equations (1) and (2) are micrometers.

For an intersection point in the virtual lattice with the oblique group number m and the horizontal group number n, its X coordinate Xk(m, n) and Y coordinate Yk(m, n) can be calculated from the following equations.

$$Xk ( m , n ) = Xk ( 0 , 0 ) + 1 69.2 n \qquad Equation ( 3 )$$

$$Yk ( m , n ) = Yk ( 0 , 0 ) + 42.3 ( 8 m + n ) \qquad Equation ( 4 )$$

The units of the calculation results of Equations (3) and (4) are micrometers.

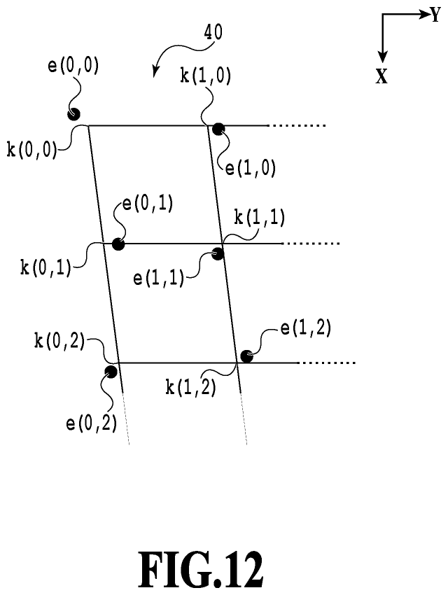

Then, based on the coordinates of each intersection point in the virtual lattice 40 and the coordinates of each landed dot, the amount of misalignment of each landed dot is calculated. FIG. 12 is an enlarged schematic diagram of a part of the virtual lattice 40 and landed dots. The amount of misalignment of a landed dot e(m, n) is derived by calculating the distance between the coordinates of the landed dot and the coordinates of the lattice intersection point k(m, n) with the same oblique group number m and horizontal group number n. For example, the amount of misalignment of the landed dot e(1, 2) can be derived by calculating the distance between the coordinates of the landed dot e(1, 2) and the coordinates of the lattice intersection point k(1, 2). In S7, for each of the element substrates C1 to C10, the CPU 12 calculates the droplet landing accuracy of the individual element substrate excluding the joint portions. Specifically, using a print pattern for an individual element substrate, the CPU 12 calculates the amounts of misalignment of all landed dots D in this printed pattern. Then, the CPU 12 calculates the sum of the calculated amounts of misalignment, and determines whether the droplet landing accuracy of the individual element substrate is good or not based on whether the calculated sum exceeds an acceptable threshold value. This is done for each element substrate.

After S7 is S8, in which the CPU 12 inspects the droplet landing accuracy at the joint portion between the element substrates. In the following, the calculation of the droplet landing accuracy at the joint portion between the element substrates C1 and C2 will be described as an example. The calculation of the droplet landing accuracy at the other joint portions is similar to this, and description thereof is therefore omitted.

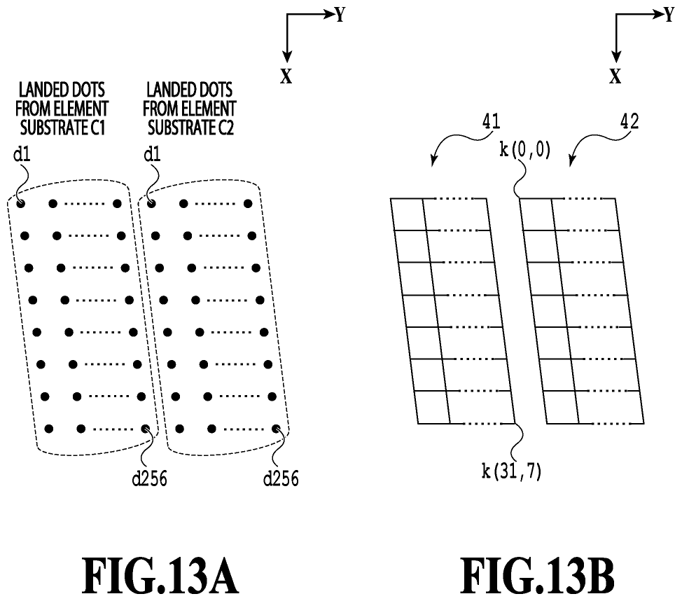

First, for a pattern including a total of 512 landed dots D printed by the element substrates C1 and C2 as illustrated in FIG. 8B, the positions in a virtual lattice are calculated for each element substrate. This calculation of the positions in the virtual lattice for each element substrate will be described with reference to FIGS. 13A and 13B.

FIG. 13A is a diagram in which the landed dots D illustrated in FIG. 8B are denoted by landed dot numbers such that the 256 landed dots from each element substrate can be recognized. The landed dots D1-257b to D1-512 from the element substrate C1 (see FIG. 8B) are numbered in FIG. 13A such that D1-257b corresponds to d1 and D1-512 corresponds to d256. Likewise, the landed dots D2-1 to D2-256 from the element substrate C2 are numbered such that D2-1 corresponds to d1 and D2-256 corresponds to d256. Thereafter, as illustrated in FIG. 13B, the positions in a virtual lattice 41 for the element substrate C1 and the positions in a virtual lattice 42 for the element substrate C2 are calculated by following the procedure described above. Note that the number of landed dots is 512 in Equations (1) and (2). This time, however, it is 256. Thus, the positions are calculated using Equations (1) and (2) with the number of landed dots changed from 512 to 256. Then, the accuracy at the joint portion is calculated based on the relative positional relationship between the virtual lattices 41 and 42. Specifically, the Y coordinate Yk(31, 7) of the rightmost (+Y side) intersection point k(31, 7) in the virtual lattice 41 for the element substrate C1 and the Y coordinate Yk(0, 0) of the leftmost intersection point k(0, 0) in the virtual lattice 42 for the element substrate C2 are derived by using Equations (3) and (4). Then, with the distance between these Y coordinates as an indicator of the droplet landing accuracy at the joint portion, whether the droplet landing accuracy is good or not is determined based on whether the value of this distance exceeds an acceptable threshold value. This is done for each joint portion. The above completes the process in the flowchart of FIG. 4, i.e., the inspection of the droplet landing accuracy in the present embodiment.

### <Effect of Present Embodiment>

As described above, in the present embodiment, a print pattern for an element substrate C is separated into first and second lines. For this reason, dot coordinates in different coordinate systems are obtained. However, the use of landed dots from the same ejection port makes it possible to represent the dot coordinates in the same coordinate system. Thus, information on droplet landing accuracy conventionally obtained from four lines of patterns can now be obtained from two lines of patterns. This reduces the amounts of paper and the ink to be consumed and thus reduces the inspection cost.

### Second Embodiment

A second embodiment will now be described below. In the following, similar elements and so on to those in the first embodiment will be represented using similar reference signs to those in the first embodiment. Moreover, as a rule, description of similar contents to those in the first embodiment will be omitted. Also, the inspection method according to the second embodiment employs the same flowchart as the flowchart in the first embodiment (FIG. 4), and will therefore be described with reference to FIG. 4.

The mounting of the liquid ejection head 10 and the placement of the print medium 28 on the inspection apparatus 20 (S1) and the print preparation (S2) are similar to those in the first embodiment, and description thereof is therefore omitted.

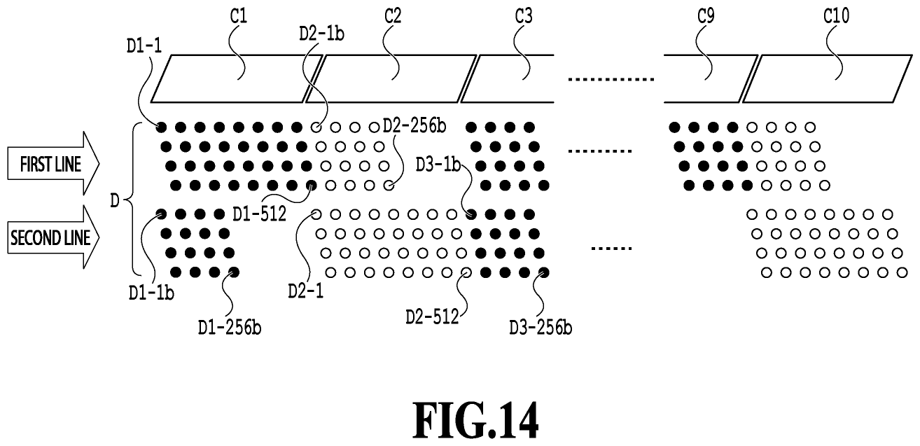

Next, in S3, the CPU 12 prints the inspection pattern illustrated in FIG. 14 on the print medium 28. FIG. 14 is a schematic diagram illustrating a positional relationship between landed dots D that were ejected from ejection ports H in the element substrates C and landed on the print medium 28. A pattern including two lines of patterns is printed per ejection port array.

The first line of the pattern is printed by using the ejection ports with ejection port numbers 1 to 512 in the odd-numbered element substrates C1, C3, . . . , C9 and the ejection ports with ejection port numbers 1 to 256 in the even-numbered element substrates C2, C4, . . . , C10. The number of landed dots in the first line ejected by using the element substrate C1 is 512 (D1-1 to D1-512), and the number of landed dots in the first line ejected by using the element substrate C2 is 256 (D2-1b to D2-256b).

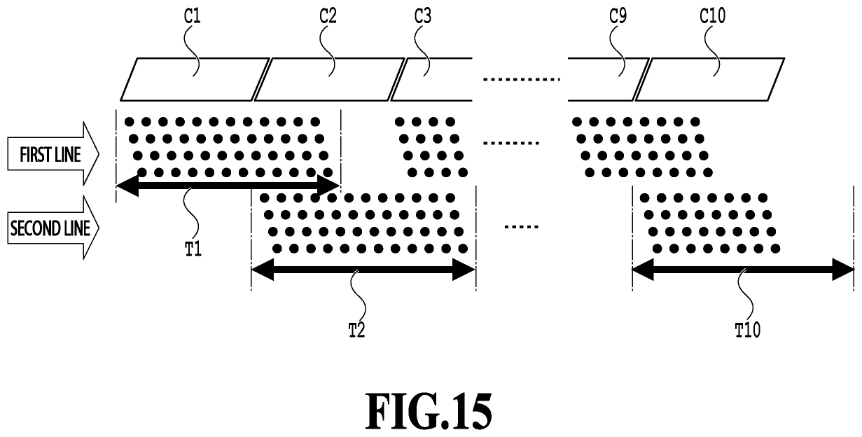

The second line is printed by using the ejection ports with ejection port numbers 1 to 256 in the odd-numbered element substrates C1, C3, . . . , C9 and the ejection ports with ejection port numbers 1 to 512 in the even-numbered element substrates C2, C4, . . . , C10. The number of landed dots in the second line ejected by using the element substrate C1 is 256 (D1-1b to D1-256b), and the number of landed dots in the second line ejected by using the element substrate C2 is 512 (D2-1 to D2-512). In FIG. 14, the black dots are illustrated as the landed dots D from the odd-numbered element substrates C1, C3, . . . , C9, and the white dots are illustrated as the landed dots D from the even-numbered element substrates C2, C4, . . . , C10. Incidentally, in FIG. 14, a pattern including the landed dots D1-1b to D1-256b is printed as a part of the second line of the pattern, but this pattern is not to be measured. Thus, its printing may be omitted. In FIG. 15, illustration of this pattern is omitted.

The reading of the pattern in S4 after S3 will now be described with reference to FIG. 15. As illustrated in FIG. 15, the pattern reading in the present embodiment is such that the entire pattern is read in 10 scans T1 to T10. The first line of the pattern is read in the odd-numbered scans T1, T3, . . . , T9, and the second line of the pattern is read in the even-numbered scans T2, T4, . . . , T10. Now, the reading in a single scan will be described by taking a scan T1 as an example. In the scan T1, the CPU 12 reads the landed dots D1-1 to D1-512 from all of the 512 ejection ports H included in a single nozzle array in the element substrate C1, and the landed dots D2-1b to D2-256b from half (256) of the ejection ports H included in a single nozzle array in the element substrate C2. The reading width is the width of 768 landed dots altogether, which is approximately 32.5 millimeters, while the reading width of the camera 25 is approximately 41 millimeters, as mentioned earlier. Thus, the landed dots can be read without a problem.

In S5, the CPU 12 obtains and stores coordinate information of all landed dots read in S4. Subsequently, in S6, the CPU 12 determines whether all of the 10 scans have been completed for the pattern reading. If the result of the determination in S6 is positive, the CPU 12 proceeds to S7. On the other hand, if the result of the determination in S6 is negative (that is, not all of the 10 scans have been completed for the pattern reading), the CPU 12 returns to S4 and repeats S4 to S6 until completing the 10 scans.

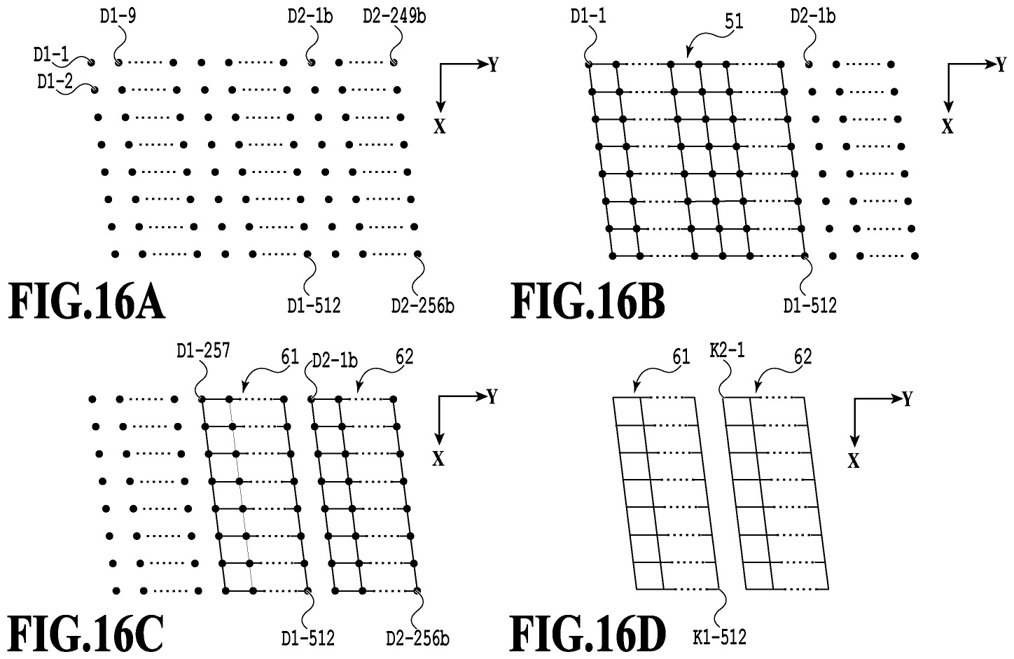

Now, the calculation of the droplet landing accuracy of each individual element substrate in S7 and the calculation of the droplet landing accuracy at each joint portion in S8 will be described below with reference to FIGS. 16A to 16D. In the following, the droplet landing accuracy of each individual element substrate will be described by taking the element substrate C1 as an example, and the droplet landing accuracy at each joint portion will be described by taking the joint portion between the element substrates C1 and C2 as an example. The methods for the other element substrates than the element substrate C1 and the other joint portions are similar, and description thereof is therefore omitted.

FIG. 16A illustrates the landed dots D read in the scan T1. Referring to FIG. 16A, there are 768 landed dots D in total including the landed dots D1-1 to D1-512 from the element substrate C1 and the landed dots D2-1b to D2-256b from the element substrate C2. The arrangement of the dots forming the inspection pattern is similar to the dot arrangement in the first embodiment. Groups of eight landed dots have landed in straight arrays of successive landed dots toward the bottom right of the drawing. Also, the ideal relative positional relationship between the landed dots is the same as that in the first embodiment.

As illustrated in FIG. 16B, as for the droplet landing accuracy of the individual element substrate C1, a virtual lattice 51 is derived by the same method as the derivation method described in the first embodiment by using the coordinates of the 512 landed dots D1-1 to D1-512. Then, the distance between the coordinates of each intersection point in the virtual lattice 51 and the coordinates of the actual landed dot corresponding to this intersection point is calculated as the amount of misalignment. Thereafter, the sum of the amounts of misalignment (corresponding to all intersection points in the virtual lattice 51) is calculated, and whether the droplet landing accuracy of the individual element substrate is good or not is determined based on whether the calculated sum exceeds an acceptable threshold value.

Next, the calculation of the droplet landing accuracy at the joint portion between the element substrates C1 and C2 will be described. As in the first embodiment, the positions in the virtual lattices for the element substrates C1 and C2 are calculated, and the droplet landing accuracy at the joint portion is calculated based on the positional relationship between these virtual lattices. FIG. 16C illustrates a virtual lattice 61 for the element substrate C1 and a virtual lattice 62 for the element substrate C2 as the virtual lattices for calculating the droplet landing accuracy at the joint portion. There are 256 landed dots from the element substrate C2. Thus, the positions in the virtual lattice 62 is calculated by using the positional coordinates of the 256 landed dot D2-1b to D2-256b. The calculation is performed by the same method as the calculation of the virtual lattice 42 in FIG. 13B described in the first embodiment.

The positions in the virtual lattice 61 for the element substrate C1 are calculated by a similar method as well. The landed dots used to calculate the positions in the virtual lattice 61 are the 256 landed dots D1-257 to D1-512. Thus, the positions are calculated with the same number of dots as that used to calculate the positions in the virtual lattice 62.

After calculating the positions in the virtual lattices 61 and 62, whether the droplet landing accuracy at the joint portion is good or not is determined based on whether the distance between the Y coordinates of a lattice intersection point K1-512 in the virtual lattice 61 and a lattice intersection point K2-1 in the virtual lattice 62 illustrated in FIG. 16D exceeds an acceptable threshold value. This completes the inspection of the droplet landing accuracy in the present embodiment.

### <Effect of Present Embodiment>

In the present embodiment, the inspection pattern is a set of patterns each formed in the form of a single patch by using all of the ejection ports of a nozzle array in an element substrate and half of the ejection ports of a nozzle array in an element substrate adjacent to the element substrate. In this way, the number of scans to read the inspection pattern is equal to the number of element substrates. Accordingly, in accordance with the present embodiment, the droplet landing accuracy is inspected in a short time as compared to the first embodiment.

### Other Embodiments

Note that the configuration of the inspection apparatus is not limited to the one described above. For example, in the above description, the camera 25 included in the inspection apparatus 20 has a short reading width, so that multiple scans need to be performed separately. Alternatively, the configuration may be such that the inspection apparatus is provided with a different camera having a longer reading width and obtains an image in a single image taking operation with the camera.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

In accordance with the present disclosure, it is possible to reduce the rise in inspection cost in a case of inspecting the droplet landing accuracy of each individual element substrate and also the droplet landing accuracy at the joint portion between the adjacent element substrates.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-072349, filed Apr. 26, 2023, which is hereby incorporated by reference wherein in its entirety.

What is claimed is:

1. An inspection method for inspecting a liquid ejection head in which a plurality of element substrates are arrayed, the plurality of element substrates each being a substrate in which are formed an ejection port array consisting of a plurality of ejection ports for ejecting a liquid, the inspection method comprising:
printing an inspection pattern on a print medium;
reading the inspection pattern printed on the print medium in the printing;
calculating droplet landing accuracy of each individual one of the plurality of element substrates based on positional coordinates of landed dots included in the inspection pattern read in the reading; and
calculating droplet landing accuracy at a joint portion between adjacent ones of the element substrates based on the positional coordinates, wherein
the inspection pattern includes a first pattern printed by using a plurality of ejection ports covering the joint portion between the adjacent element substrates, and a second pattern printed by using ejection ports not used in the printing of the first pattern and at least one of the ejection ports used in the printing of the first pattern.

2. The inspection method according to claim 1, wherein the inspection pattern includes two lines of patterns as the first pattern and the second pattern.

3. The inspection method according to claim 1, wherein the at least one ejection port that ejects the liquid in both the printing of the first pattern and the printing of the second pattern is a substantially center ejection port in the ejection port array.

4. The inspection method according to claim 1, wherein the printing includes printing the inspection pattern while conveying the print medium in a direction orthogonal to an array direction of the plurality of element substrates.

5. The inspection method according to claim 1, further comprising obtaining information of the positional coordinates.

6. The inspection method according to claim 1, wherein the calculating the droplet landing accuracy of each individual one of the plurality of element substrates includes:
deriving a single virtual lattice based on a first landed dot coordinate read from the first pattern and a second landed dot coordinate read from the second pattern; and
calculating the droplet landing accuracy of the individual element substrate by using the single virtual lattice.

7. The inspection method according to claim 1, wherein the calculating the droplet landing accuracy at the joint portion includes:
deriving a first virtual lattice and a second virtual lattice based on landed dot coordinates read from one of the first pattern or the second pattern;
calculating the droplet landing accuracy at the joint portion based on a relative positional relationship between the first virtual lattice and the second virtual lattice.

8. The inspection method according to claim 7, wherein the adjacent element substrates are a first element substrate in which are formed ejection ports corresponding to the landed dot coordinates to be used to derive the first virtual lattice, and a second element substrate in which are formed ejection ports corresponding to the landed dot coordinates to be used to derive the second virtual lattice.

9. The inspection method according to claim 8, wherein
the first virtual lattice is derived based on landed dot coordinates of the same number of landed dots as virtual lattice intersection points in the first virtual lattice, and
the second virtual lattice is derived based on landed dot coordinates of the same number of landed dots as virtual lattice intersection points in the second virtual lattice.

10. The inspection method according to claim 1, wherein the first pattern and the second pattern are each a pattern in the form of a single patch printed by using all of the ejection ports of the ejection port array formed in one of the plurality of element substrates and half of the ejection ports of the ejection port array formed in an element substrate adjacent to the one element substrate.

11. The inspection method according to claim 10, wherein the number of times the inspection pattern is read in the reading is equal to the number of the plurality of element substrates arrayed in the liquid ejection head.

12. A non-transitory computer-readable storage medium storing a program that causes a computer to execute an inspection method for inspecting a liquid ejection head in which a plurality of element substrates are arrayed, the plurality of element substrates each being a substrate in which are formed an ejection port array consisting of a plurality of ejection ports for ejecting a liquid, the inspection method comprising:
printing an inspection pattern on a print medium;
reading the inspection pattern printed on the print medium in the printing;
calculating droplet landing accuracy of each individual one of the plurality of element substrates based on positional coordinates of landed dots included in the inspection pattern read in the reading; and
calculating droplet landing accuracy at a joint portion between adjacent ones of the element substrates based on the positional coordinates, wherein
the inspection pattern includes a first pattern printed by using a plurality of ejection ports covering the joint portion between the adjacent element substrates, and a second pattern printed by using ejection ports not used in the printing of the first pattern and at least one of the ejection ports used in the printing of the first pattern.
